(19) United States
(12) Patent Application Publication
(10) Pub. No.: US 2016/0342431 A1
(43) Pub. Date: Nov. 24, 2016

(54) INTERACTIVE HELP INTERFACE

(71) Applicant: Bank of America Corporation, Charlotte, NC (US)

(72) Inventor: Tau Huang, Bellevue, WA (US)

(21) Appl. No.: 14/719,600

(22) Filed: May 22, 2015

(51) Int. Cl. G06F 9/44; G06F 17/30; G06F 3/0484

(52) U.S. Cl. CPC G06F 9/4446; G06F 3/04842; G06F 17/3089

(57) ABSTRACT

Methods for enabling an interactive help panel are provided. Methods may display a webpage. Methods may display a moveable cursor. Methods may display an interactive help panel, which may provide video and/or textual assistance. Methods may broadcast audio assistance using a broadcast system. In response to opening of the webpage, a processor may preload an assistance video, associated with the opened webpage, to a memory location. The memory location may be within a hardware memory. When the cursor is moved by a user, the processor may determine which pixels the cursor traversed and an amount of time the cursor occupied each pixel. In response to the cursor remaining within a predetermined block of pixels for a predetermined period of time, the processor may display assistance in the interactive help panel. The assistance may correspond to information corresponding to the predetermined block of pixels.

### FIELD OF TECHNOLOGY

This invention relates to computer-implemented assistance. Specifically, this invention relates to interactive help interfaces.

### BACKGROUND OF THE DISCLOSURE

Millions of users view, and interact with, numerous webpages daily. Each webpage may include various graphics, text, information, tutorials, instructions and/or directions. While interacting with a webpage, a user may require assistance to complete a task at hand. A user may also require assistance to learn more information relating to a displayed product. A user may also require assistance with a technological issue he or she encountered. A user may also require assistance in many other suitable instances.

Conventionally, a webpage included a “quick-help” button or text entry field. At times a user would click on the “quick-help” button. The system would present a text entry field to the user. The user would enter a question, via a user input device, into the text entry field. The system would then present to the user a list of possible answers to the submitted question.

Many users, in need of help, do not use “quick-help” because of the effort required to obtain the “quick-help”. Other users, in need of assistance, forget to utilize the “quick-help” feature. Typically, these users either become frustrated or contact live customer representatives. Frustrated customers or customers who contact live customer assistance representatives may unnecessarily utilize strained resources.

Therefore, a need exists for an interactive help panel which provides interactive help to the user prior to the user requesting assistance.

### SUMMARY OF THE INVENTION

An apparatus for enabling an interactive help panel is provided. The apparatus may include a processor. The apparatus may include a display. The display may include pixels. The apparatus may include a moveable cursor. The moveable cursor may be viewable on the display. The moveable cursor may be associated with a user via an input device. The apparatus may include an interactive help panel. The interactive help panel may be viewable on the display. The interactive help panel may be configured to provide video and/or textual assistance to the user. The apparatus may also include a broadcasting system. The broadcasting system may be for broadcasting audio assistance to the user.

In response to opening of the webpage by the user, the processor may be configured to preload an assistance video to a memory location within a hardware memory associated with the user. The assistance video may be associated with the opened webpage. When the cursor is moved by the user, the processor may be configured to determine which pixels the cursor traversed and an amount of time the cursor occupied each pixel. The amount of time may be two seconds, or any other suitable amount of time. The processor may discard information pertaining to cursor traversals that have occurred more than three minutes ago, or any other suitable amount of time. In response to the cursor remaining within a predetermined block of pixels for a predetermined period of time, the processor may be configured to display assistance corresponding to the predetermined block of pixels in the interactive help panel.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative apparatus in accordance with principles of the invention;

FIG. 2 shows an illustrative apparatus in accordance with the principles of the invention;

FIG. 3 shows an illustrative diagram according to certain embodiments;

FIG. 4 shows an illustrative diagram according to certain embodiments;

FIG. 5A shows an illustrative diagram according to certain embodiments;

FIG. 5B shows an illustrative diagram according to certain embodiments;

FIG. 5C shows an illustrative diagram according to certain embodiments;

FIG. 6 shows an illustrative flow chart according to certain embodiments; and

FIG. 7 shows an illustrative flow chart according to certain embodiments.

### DETAILED DESCRIPTION OF THE DISCLOSURE

An apparatus for enabling an interactive help panel is provided. The apparatus may include a processor. The apparatus may include a webpage. The webpage may be displayed on a display. The display may include pixels. The pixels may be divided into a pixel grid. The pixel grid may include sections. Each section of the pixel grid may correspond to a category. The category may be determined, in part, by a portion of the webpage displayed on the section.

The apparatus may also include a moveable cursor. The moveable cursor may be viewable on the display. The moveable cursor may appear in many shapes and forms. The moveable cursor may appear as a pointer, a text cursor, four arrows, or any other suitable symbol.

The moveable cursor may be associated with a user via an input device. The input device may be a keyboard, mouse, stylus, audio recognition device, or any other suitable input device.

The apparatus may also include an interactive help panel. The interactive help panel may be displayed on the display. The interactive help panel may provide audio and/or textual assistance to the user.

The apparatus may include a broadcast system. The broadcast system may be for broadcasting audio assistance. The broadcast system may be for broadcasting audio corresponding to video assistance.

In response to opening of the webpage by the user, the processor may be configured to preload all assistance videos associated with the opened webpage to a memory location. The memory location may be within a hardware memory. The hardware memory may be associated with the user. The hardware memory may be associated with the user workstation.

When the cursor is moved by the user, the processor may determine which pixels, or which group of pixels, the cursor traversed and an amount of time the cursor occupied each pixel. In response to the cursor remaining within a predetermined block of pixels for a predetermined period of time, the processor may display assistance in the interactive help panel. The assistance may correspond to information corresponding to the predetermined block of pixels.

When the cursor is moved by the user, the processor may determine which sections the cursor traversed and an amount of time the cursor occupied each section. In response to the cursor remaining within a section for a predetermined amount of time, the processor may display assistance in the interactive help panel. The displayed assistance may correspond to the category of the section.

The assistance may also include additional information relating to the section. For example, if a section corresponds to a pipe displayed on the webpage, the interactive help panel may display measurements relating to the pipe and information pertaining to installation of the pipe.

The processor may be a server-side processor. The server side processor may be located in a remote location from the display. The processor may also be a client-side processor. The client-side processor may be located in substantially the same location as the display.

The processor may be a plurality of processors. At least one of the plurality of processors may be server-side processor. The server-side processor may be located in a remote location from the display. At least one of the plurality of processors may be a client-side processor. The client-side processor may be located in substantially the same location as the display.

The processor may record the trajectory of the cursor. In response to the cursor moving in a predetermined trajectory with respect to sections of the pixel grid, the processor may display, in the interactive help panel, assistance relating to a predicted target associated with the trajectory.

The predetermined trajectory may be based in part on prior user history. The predetermined trajectory may be based in part on prior webpage history. The prior webpage history may include information corresponding to other users of the webpage.

The assistance may be related to a predicted location. The predicted location may be a cursor location. The predicted location may be based in part on the trajectory.

The apparatus may also include a trajectory category index. The trajectory category index may correlate cursor trajectories to categories.

The processor may utilize the trajectory category index to determine which category the assistance, displayed in the interactive help panel, should be correlated.

The displayed assistance may include the assistance video. The displayed assistance may include textual assistance.

The audio assistance may be pre-recorded. The audio assistance may be live. The textual assistance may be pre-recorded. The textual assistance may be live.

The apparatus may include a second hardware memory. The hardware memory may be called a first hardware memory. The first hardware memory may be located at substantially the same location as the display. The assistance video may be retrieved from the first hardware memory. The second hardware memory may be located at a remote location from the display. The audio assistance may be retrieved from the second hardware memory. The textual assistance may be retrieved from the second hardware memory.

The preloading may be implemented as a transmission from the second hardware memory to the first hardware memory.

The assistance video may be displayed on the display in response to retrieval of the assistance video from local memory. The audio assistance may be broadcast. The broadcast may be in real time. The broadcast may be in response to receipt of data corresponding to the audio assistance. The receipt of data may be from the server-side processor. The textual assistance may be displayed in real time. The textual assistance may be displayed in response to receipt of data corresponding to the textual assistance. The receipt of data may be from the server-side processor.

The displayed assistance may be a first display of assistance. In response to the user executing an activity included in the first display of assistance, the processor may display a second display of assistance. This may be for “How-to” assistance videos. There may also be numerous displays of assistance.

The processor may utilize software for retrieving the correct assistance. One illustrative, possible embodiment may utilize the computer-readable pseudo code included as Table A.

TABLE A

```
Each field which has assistance content associated with it may be
linked to the method onPageLoadReady
onPageLoadReady( ){
  Map helpcontents = ajaxCall(‘loadHelpContents’)
}
Var currentFocusField = getFocusField( );
onCursorFocus( ){
  if (helpWindow = off ) return;
  if(getFocusField( ) == currentFocusField ){
    return;
  }else{
    currentFocusField = getFocusField( );
    startTime = systemTime( );
    if(helpcontents.key exist){
      preload(key);
    }
    sleep(2 secs);
    if(getFocusField( ) == currentFocusField ){
      displayHelpContent( );
    }
  }
}
preload(key){
  helpcontents(key) = ajaxcall(‘loadvideo(key)’);
}
displayHelpContent( ){
  if( helpcontents.key exist ){
    display( );
  }
}
```

In some embodiments, the webpage may not load the video immediately until the cursor remains on a section for at least two seconds, or any other suitable time period. Two seconds, or any other suitable time period, may be enough time to load a relatively small video clip. The two second wait may avoid traffic on the server side processor.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

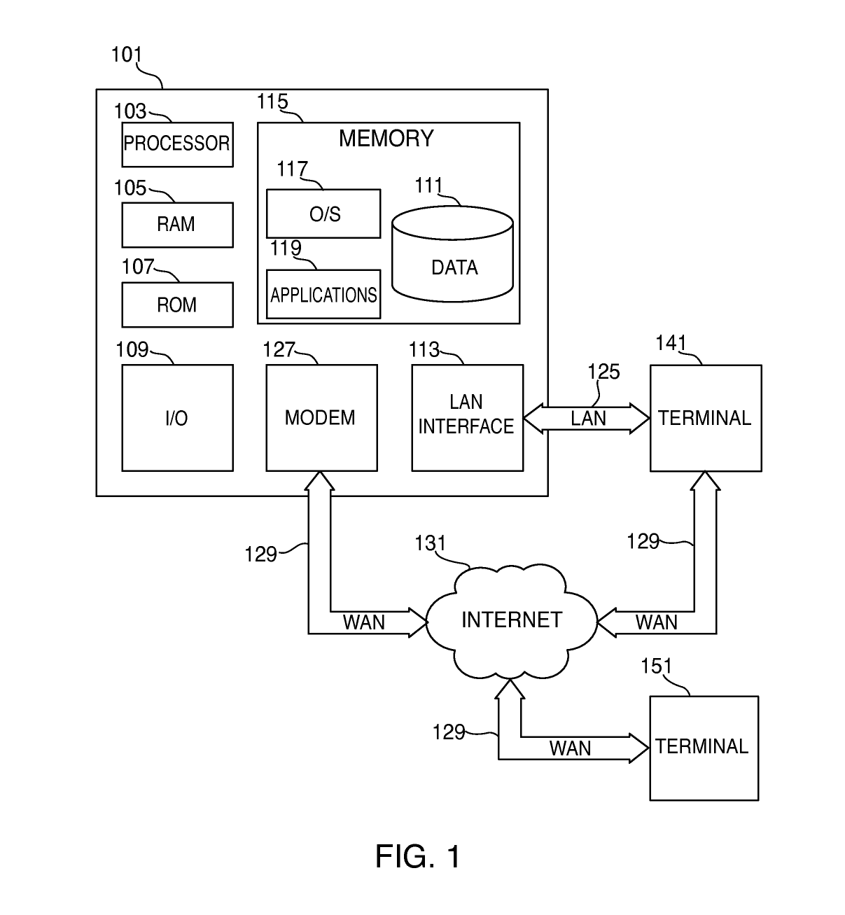

FIG. 1 shows an illustrative block diagram of system 100 based on computer 101. The computer 101 may have a processor 103 for controlling the operation of the device and its associated components, and may include RAM 105, ROM 107, input/output module 109, and a memory 115. The processor 103 will also execute all software running on the computer—e.g. the operating system and/or voice recognition software. Other components commonly used for computers, such as EEPROM or Flash memory or any other suitable components, may also be part of the computer 101.

The memory 115 may be comprised of any suitable permanent storage technology—e.g., a hard drive. The memory 115 stores software including the operating system 117 any application(s) 119 along with any data 111 needed for the operation of the system 100. Memory 115 may also store videos, text, and/or audio assistance files. The videos, text, and/or audio assistance files may also be stored in cache memory, or any other suitable memory. Alternatively, some or all of computer executable instructions may be embodies in hardware or firmware (not shown). The computer 101 executes the instructions embodied by the software to perform various functions.

Input/output (“I/O”) module may include connectivity to a microphone, keyboard, touch screen, mouse, and/or stylus through which a user of computer 101 may provide input. The input may include input relating to cursor movement. The input/output module may also include one or more speakers for providing audio output and a video display device for providing textual, audio, audiovisual, and/or graphical output. The textual, audio, audiovisual and graphical output may correspond to assistance the user may require.

System 100 may be connected to other systems via a LAN interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server. The web-based server may transmit data e.g., assistance videos to any other suitable computer system. The web-based server may also send computer-readable instructions, together with the data, to any suitable computer system. The computer-readable instructions may be to store the data in cache memory, the hard drive, secondary memory, or any other suitable memory. The transmission of the data together with computer-readable instructions may enable the computer system to quickly retrieve the data, when needed. Because the computer system is able to quickly retrieve the data, the web-based server need not stream the data to the computer system. This may be beneficial for the computer system, because the retrieval may be faster than data-streaming. Users may not become frustrated because they do not need to wait to view the assistance video. Conventionally, streaming data requires heavy usage of the processor and the cache memory. If the data is stored in the computer system's memory, retrieval of the data may not require heavy processor and cache memory usage. Any of various conventional web browsers can be used to display and manipulate retrieved data on web pages.

Additionally, application program(s) 119, which may be used by computer 101, may include computer executable instructions for invoking user functionality related to communication, such as e-mail, Short Message Service (SMS), and voice input and speech recognition applications.

Computer 101 and/or terminals 141 and 151 may also be devices including various other components, such as a battery, speaker, antennas (not shown).

Terminal 151 and/or terminal 141 may be portable devices such as a laptop, cell phone, Blackberry™, smartphone, or any other suitable device for storing, transmitting and/or transporting relevant information. Terminals 151 and/or terminal 141 may be other devices. These devices may be identical to system 100 or different. The differences may be related to hardware components and/or software components.

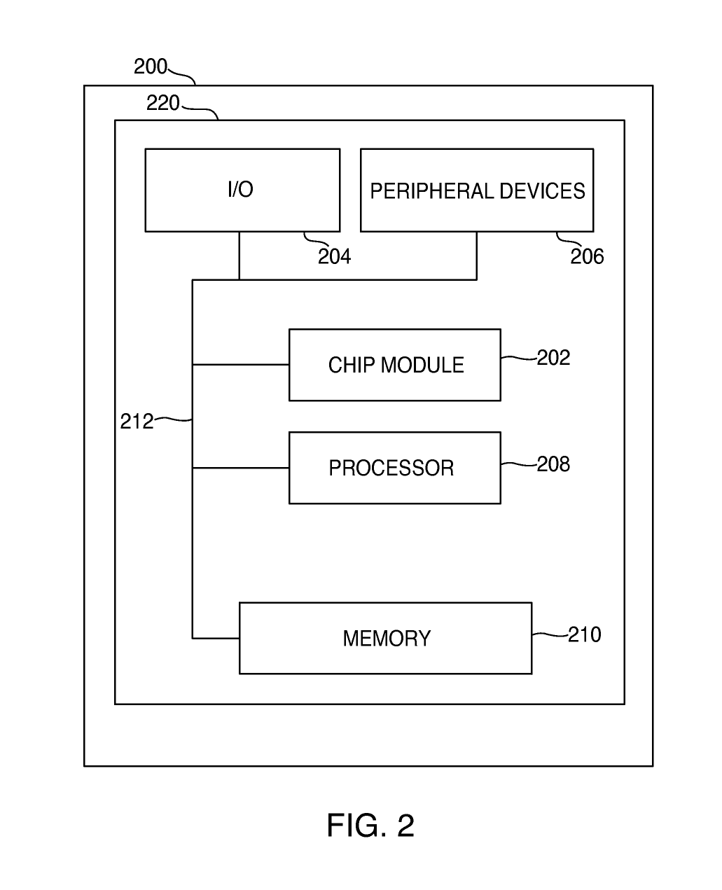

FIG. 2 shows illustrative apparatus 200. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver cable and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information, structural parameters of the data, predict possible cursor trajectories and machine-readable memory 210.

Machine-readable memory 210 may be configured to store in machine-readable data structures: information pertaining to a user, assistance videos, audio assistance, textual assistance, information pertaining to a webpage, information pertaining to technical difficulties users encountered with a webpage, information pertaining to a pixel grid associated with a display, information pertaining to cursor trajectories, information pertaining to sections of a webpage, information pertaining to a cursor movement, information pertaining to cursor movement as related to webpage sections and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon based.

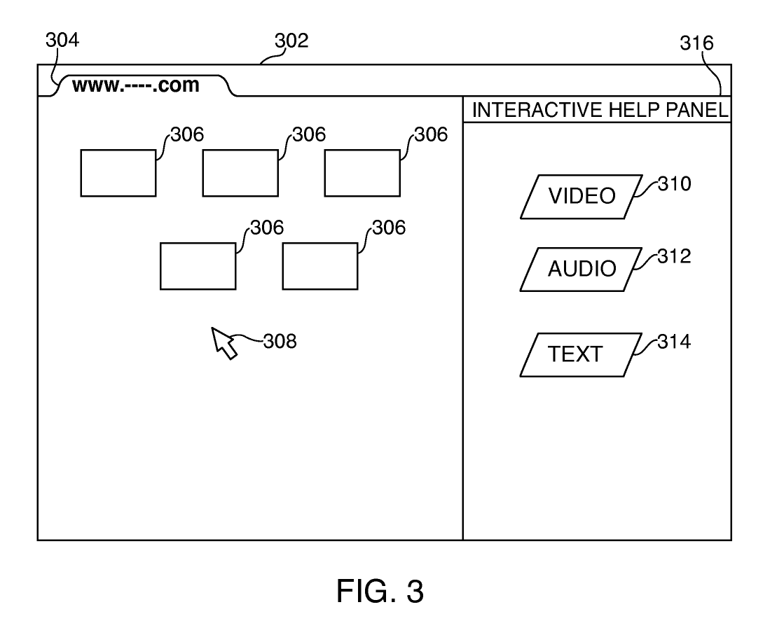

FIG. 3 shows display 302. Display 302 may include pixels. Webpage 304 may be displayed on display 302. Interactive help panel 316 may also be displayed on display 302. Interactive help panel 316 may be a part of webpage 304. Interactive help panel 316 may be separate from webpage 304. Interactive help panel 316 may be for providing video assistance 310, audio assistance 312 and textual assistance 314. Video assistance 310 and audio assistance 312 may require the use of a broadcasting or speaker system (not shown).

Cursor 308 is viewable on webpage 304. Cursor 308 may also be viewable on interactive help panel 316. Cursor 308 may be associated with a user, via an input device. The input device may be a mouse, keyboard, stylus or any other suitable input device.

The pixels of display 302 may be divided into discrete sections 306. Each of sections 306 may correspond to a discrete display of information included on webpage 304.

Upon opening of webpage 304, a remote processor (not shown) may transmit assistance videos to local memory associated with display 302. The assistance videos may correspond to the content of webpage 304. Interactive help panel 316 may or may not display one or more of the transmitted assistance videos. If the user requires assistance corresponding to a video, included in the transmitted videos, the processor may display the appropriate video.

Upon movement of cursor 308, either a local processor (not shown) or a remote processor (not shown), may record the movement of the cursor. In response to the cursor remaining in a specific section longer than a predetermined period of time, the processor may display assistance in the interactive help panel corresponding to the section on which the cursor remained.

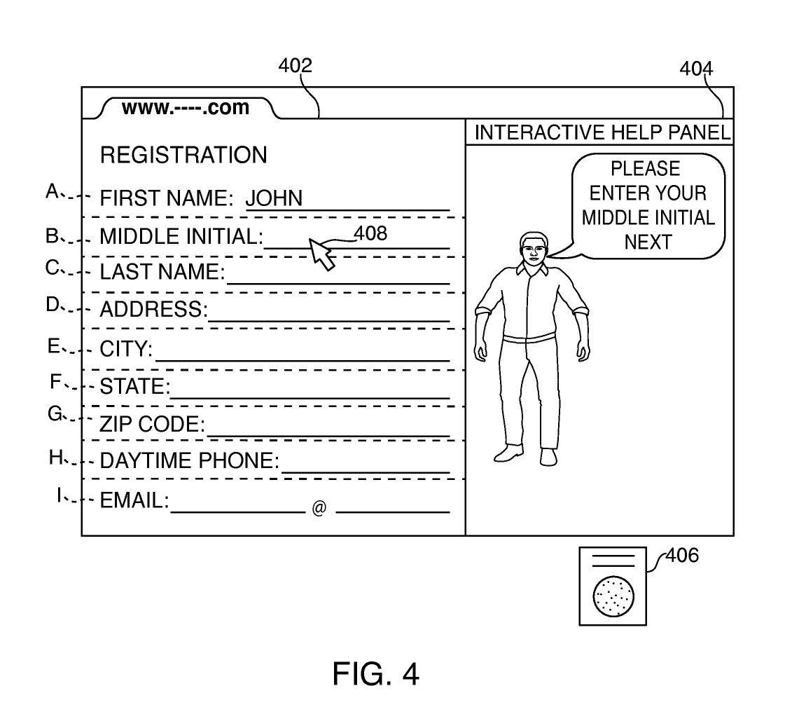

FIG. 4 shows webpage 402. Interactive help panel 404 may be included on webpage 402. Interactive help panel 404 may be a separate entity from webpage 402. Webpage 402 is an illustrative registration page for fictional website www.----.com.

Webpage 402 may include sections A, B, C, D, E, F, G, H and I. Section A may correspond to an entry field for a first name. Section B may correspond to an entry field for a middle initial. Section C may correspond to an entry field for a last name. Section D may correspond to an entry field for an address. Section E may correspond to an entry field for a city. Section F may correspond to an entry field for a state. Section G may correspond to an entry field for a zip code. Section H may correspond to an entry field for a daytime phone number. Section I may correspond to an entry field for an email address.

Moveable cursor 408 may be situated on section B. Moveable cursor 408 may remain on section B longer than a predetermined period of time. Because moveable cursor 408 remained on section B longer than a predetermined period of time, a processor may determine that a user of webpage 402 may require assistance corresponding to section B. Therefore, the processor may display an assistance video to the user in interactive help panel 404. The assistance video may correspond to the information included in section B. Because section B corresponds to a middle initial, the assistance video displayed may relate to entering a middle initial into a registration webpage. Broadcast system 406 may broadcast audio or audiovisual assistance relating to entering a middle initial into a registration webpage.

If a user does not which to view the interactive help panel, the user may minimize the interactive help panel at any time. The user may maximize the interactive help panel, to view the interactive help panel, at any suitable time. If the user is utilizing a touch screen device, the user may hide and unhide the interactive help panel utilizing a sliding motion.

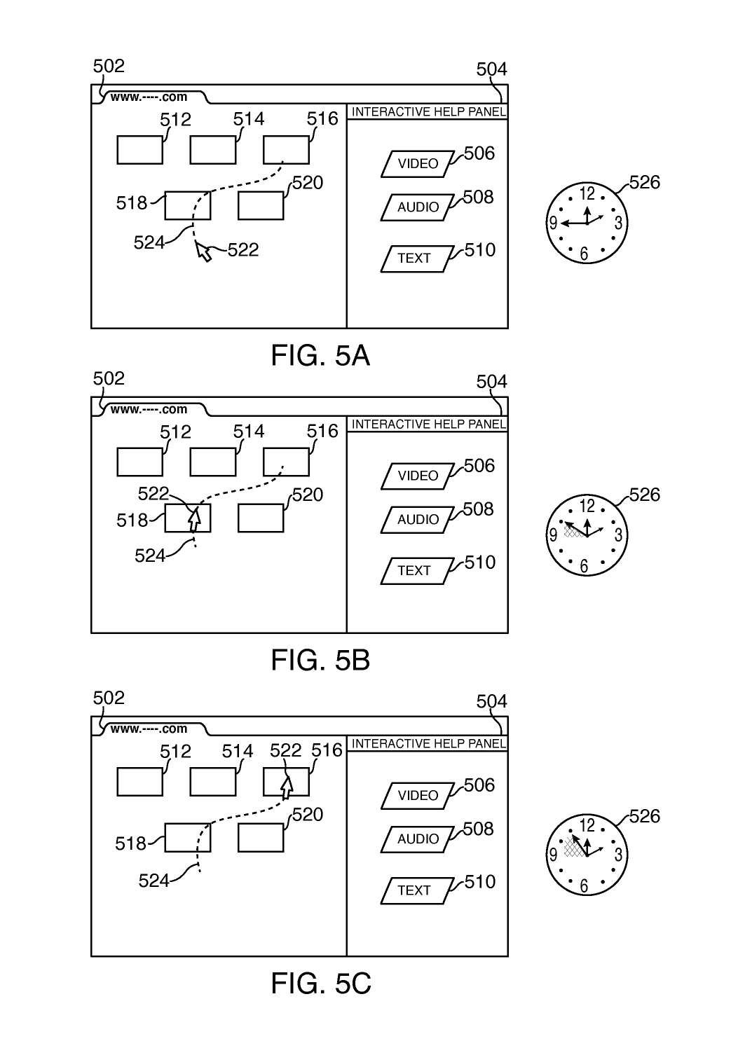

FIGS. 5A, 5B and 5C show webpage 502 during a time period. Clock 526 shows time passing from FIG. 5A to FIG. 5B and from FIG. 5B to FIG. 5C.

Sections 512, 514, 516, 518 and 520 may be discrete sections corresponding to discrete segments of information included on webpage 502.

Interactive help panel 504, may provide video assistance 506, audio assistance 508 and/or textual assistance 510. Interactive help panel 504 may utilize a broadcast system to provide audio and audiovisual assistance.

In FIG. 5A, clock 526 may display a time. The time may be 12:45. At 12:45, moveable cursor 522 may be at the beginning of trajectory 524.

In FIG. 5B, clock 526 may display a time. The time may be later than the time displayed in FIG. 5A. The time may be 12:50. At 12:50, moveable cursor 522 may be located on section 518 in the middle of trajectory 524. At this time, a processor may determine the projected completed trajectory. The processor may determine that a user may move cursor 522 to section 516 in approximately five minutes. The processor may calculate the determination based on prior personal user history and prior webpage history. The prior webpage history may include information pertaining to other users and information pertaining to cursor trajectories of other users.

Interactive help panel 504, in FIG. 5B, may display assistance relating to section 516. This may be because the projected cursor trajectory may include section 516 in a future time.

FIG. 5C shows clock 526 displaying a time. The time may be 12:55. The time may be later than the times displayed in FIGS. 5A and 5B. Moveable cursor 522 may be at the end of trajectory 524. Moveable cursor 522 may be located on section 516, as was projected by the processor.

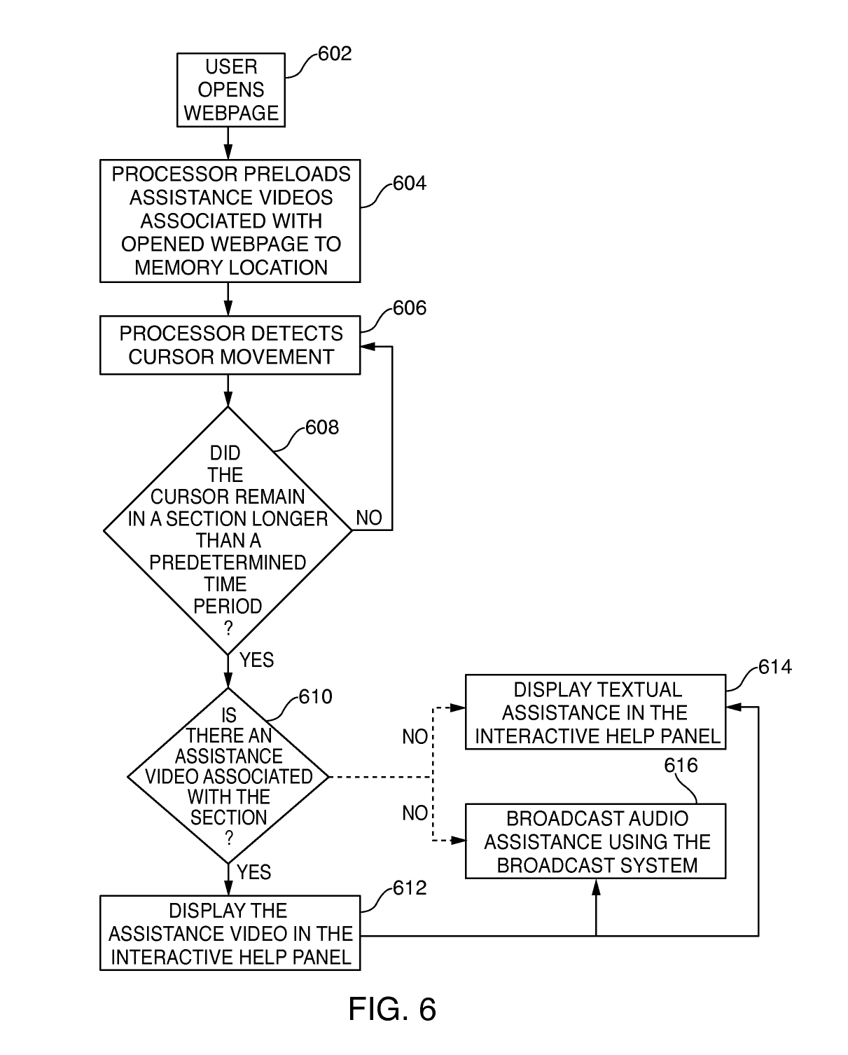

FIG. 6 shows a flow chart. Step 602 shows a user opens a webpage. Step 604 shows a processor may preload assistance videos associated with the opened webpage to a memory location. The processor may be a local processor. The processor may be a remote processor. The processor may preload substantially all assistance videos associated with the opened webpage to a memory location. The processor may preload a subset of substantially all assistance videos associated with the opened webpage to a memory location.

The subset of the assistance videos may be determined dynamically. Web-crawling machines, utilizing web-crawling and/or machine-learning algorithms, may determine issues that a potential webpage user may encounter with a specific webpage. Information pertaining to prior user behavior and/or information pertaining to the behavior of many users who interacted with the webpage may be used by the machine-learning algorithms. The machine-learning algorithms may continuously or periodically update a library of assistance videos.

The memory location may be local memory. The memory location may be cache memory. The memory may be any other suitable memory.

Step 606 shows the processor may detect cursor movement. Step 608 shows a query. The query may be “Did the cursor remain in a section longer than a predetermined time period?” If the cursor did not remain in a section longer than a predetermined time period, the process proceeds back to step 606. If the cursor did remain in a section longer than a predetermined time period, the process proceeds to step 610.

Step 610 shows a query. The query may be “Is there an assistance video associated with the section?” If there is an assistance video associated with the section, the process proceeds to step 612.

In step 612, the appropriate assistance video is displayed in the interactive help panel. The process proceeds from step 612 to step 614 or step 616.

If there is no assistance video associated with the section, as shown at step 610, the process proceeds to step 614 or step 616.

In step 614, the process may display textual assistance in the interactive help panel.

In step 616, the process may broadcast audio assistance in the interactive help panel. The audio assistance may correspond to an assistance video. The audio assistance may not correspond to an assistance video.

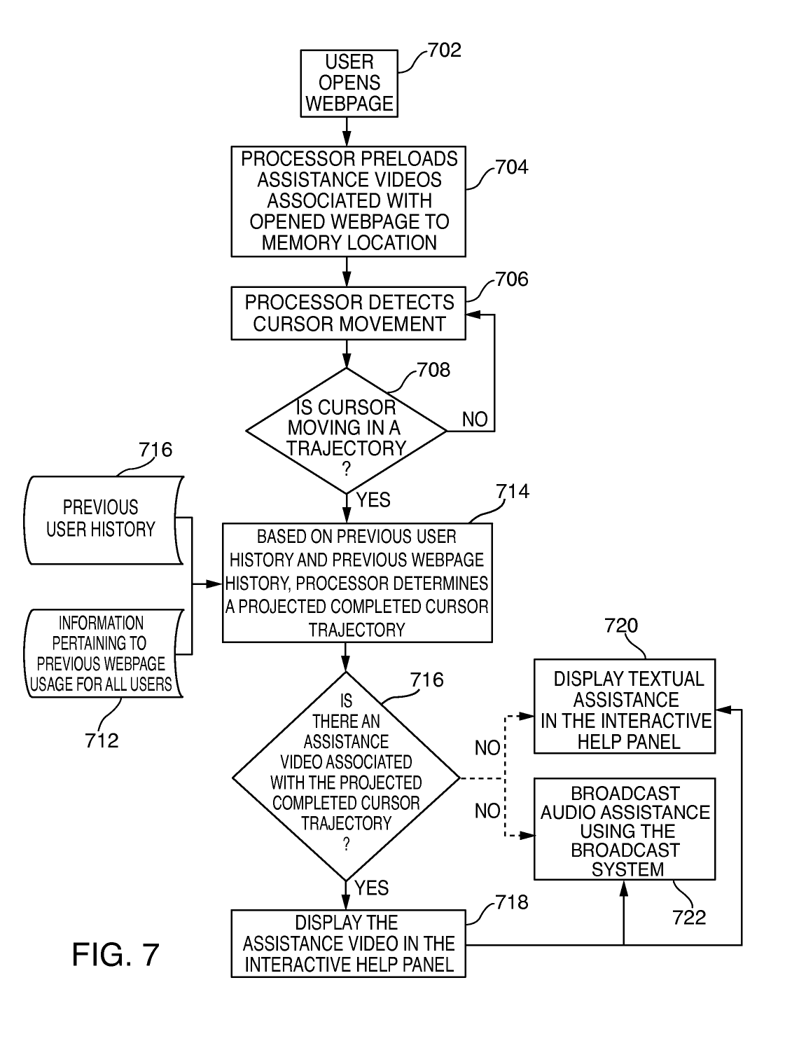

FIG. 7 shows a flow chart. Step 702 shows a user may open a webpage. Step 704 shows a processor may preload assistance videos associated with the opened webpage to a memory location. The processor may be local or remote. The memory location may be a local or remote.

Step 706 shows the processor may detect cursor movement. Step 708 shows a query. The query may be “Is the cursor moving in a trajectory?” If the cursor is not moving in a trajectory, the process may proceed back to step 706. If the cursor is moving in a trajectory, the process may proceed to step 714.

Step 714 may receive input from data 710 and 712. Data 710 may relate to previous user history. Data 712 may relate to information pertaining to previous webpage usage for all users. Data 710 and 712 may feed into step 714. Step 714 shows that, based on previous user history and previous webpage history, a processor may determine a projected completed cursor trajectory.

Step 716 shows a query. The query may be “Is there an assistance video associated with the projected completed cursor trajectory?” If there is an assistance video associated with the projected completed cursor trajectory, the process may proceed to step 718.

The assistance video may be displayed in the interactive help panel, as shown in step 718. The process may proceed to steps 720 and/or 722.

If there is no assistance video associated with the projected completed cursor trajectory, the process may proceed to steps 720 and/or 722.

Textual assistance may be displayed in the interactive help panel, as shown in step 720.

Audio assistance may be broadcast using a broadcast system, as shown in step 722.

Thus, methods and apparatus for enabling an interactive help interface are provided. Persons skilled in the art will appreciate that the present invention can be practiced by other than the described embodiments, which are presented for purposes of illustration rather than of limitation, and that the present invention is limited only by the claims that follow.

What is claimed is:

1. An apparatus for enabling an interactive help panel comprising:
a processor;
a display, said display comprising pixels;
a webpage displayed on the display;
a moveable cursor that is viewable on the display and associated with a user via an input device;
an interactive help panel configured to provide video and/or textual assistance to the user, said panel viewable on the display;
a broadcast system for broadcasting audio assistance to the user;
wherein:
in response to opening of the webpage by the user, the processor preloads an assistance video, associated with the opened webpage, to a memory location within a hardware memory associated with the user;
when the cursor is moved by the user, the processor determines which pixels the cursor traversed and an amount of time the cursor occupied each pixel, and in response to the cursor remaining within a predetermined block of pixels for a predetermined period of time, the processor displays assistance in the interactive help panel, said assistance corresponding to information corresponding to the predetermined block of pixels.

2. The apparatus of claim 1, wherein the processor is a server-side processor located in a remote location from the display.

3. The apparatus of claim 1, wherein the processor is a client-side processor located in substantially the same location as the display.

4. The apparatus of claim 1, wherein the processor is comprised of a plurality of processors, and at least one of the plurality of processors is a server-side processor located in a remote location from the display, and at least one of the plurality of processors is a client-side processor located in substantially the same location as the display.

5. The apparatus of claim 4, wherein the displayed assistance includes the assistance video.

6. The apparatus of claim 5, wherein the displayed assistance includes textual assistance.

7. The apparatus of claim 6, wherein:
the audio assistance is pre-recorded; and
the textual assistance is pre-recorded.

8. The apparatus of claim 7, wherein:
the audio assistance is live; and
the textual assistance is live.

9. The apparatus of claim 4 further comprising a second hardware memory, wherein:
the hardware memory is a first hardware memory;
the first hardware memory is located at substantially the same location as the display;
the assistance video is retrieved from the first hardware memory;
the second hardware memory is located at a remote location from the display;
the audio assistance is retrieved from the second hardware memory; and
the textual assistance is retrieved from the second hardware memory.

10. The apparatus of claim 9, wherein the preloading is from the second hardware memory to the first hardware memory.

11. The apparatus of claim 10, wherein:
the assistance video is displayed on the display in response to retrieval of the assistance video from local memory;
the audio assistance is broadcast in real time in response to receipt of data corresponding to the audio assistance from the server-side processor; and
the textual assistance is displayed in real time in response to receipt of data corresponding to the textual assistance from the server-side processor.

12. The apparatus of claim 1, wherein the displayed assistance is a first display of assistance, and in response to the user executing an activity included in the first display of assistance, the processor displays a second display of assistance in the interactive help panel.

13. One or more non-transitory computer-readable media storing computer-executable instructions which, when executed by a processor on a computer system, perform a method for enabling an interactive help panel, the method comprising:
displaying, using a processor, a webpage, on a display that comprises pixels;
displaying, using the processor, a moveable cursor, on the display, said moveable cursor associated with a user via an input device;
displaying, using the processor, an interactive help panel, on the display, said interactive help panel configured to provide video and/or textual assistance to the user;
broadcasting, using a broadcast system, audio assistance;
wherein:
in response to opening of the webpage by the user, the processor preloads an assistance video, associated with the opened webpage, to a memory location within a hardware memory associated with the user;
when the cursor is moved by the user, the processor determines which pixels the cursor traversed and an amount of time the cursor occupied each pixel, and in response to the cursor remaining within a predetermined block of pixels for a predetermined period of time, the processor displays assistance in the interactive help panel, said assistance corresponding to information corresponding to the predetermined block of pixels.

14. The method of claim 13, wherein the processor is comprised of a plurality of processors, and at least one of the plurality of processors is a server-side processor located in a remote location from the display and at least one of the plurality of processors is a client-side processor located in substantially the same location as the display.

15. The method of claim 14, further comprising retrieving audio assistance from a second hardware memory, said second hardware memory located at a remote location from the display, wherein:
the hardware memory is a first hardware memory;
the first hardware memory is located at substantially the same location as the display;
the assistance video is retrieved from the first hardware memory;
the audio assistance is retrieved from the second hardware memory; and
the textual assistance is retrieved from the second hardware memory.

16. The apparatus of claim 15, wherein:
the assistance video is displayed on the display in response to retrieval of the assistance video from local memory;
the audio assistance is broadcast in real time in response to receipt of data corresponding to the audio assistance from the server-side processor; and
the textual assistance is displayed in real time in response to receipt of data corresponding to the textual assistance from the server-side processor.

17. An apparatus for enabling an interactive help panel, the apparatus comprising:
a processor;
a webpage displayed on a display, said display comprising pixels, said pixels being divided into a pixel grid comprising sections, each section of the pixel grid corresponding to a category, the category being determined, at least in part, by a portion of the webpage displayed on the section;
a moveable cursor that is viewable on the display and associated with a user via an input device;
an interactive help panel, displayed on the display, for providing video and/or textual assistance to the user;
a broadcast system for broadcasting audio assistance;
wherein:
in response to opening of the webpage by the user, the processor preloads all assistance videos associated with the opened webpage, to a memory location within a hardware memory associated with the user;
when the cursor is moved by the user, the processor determines which sections the cursor traversed and an amount of time the cursor occupied each section, and in response to the cursor remaining within a section for a predetermined amount of time, the processor is configured to display assistance in the interactive help panel, said assistance corresponding to the category of the section.

18. The apparatus of claim 17, wherein the processor records the trajectory of the cursor, and in response to the cursor moving in a predetermined trajectory with respect to the sections of the pixel grid, the processor displays, in the interactive help panel, assistance relating to the trajectory.

19. The apparatus of claim 18, wherein the assistance is related to a predicted location based on the trajectory.

20. The apparatus of claim 19, wherein the apparatus further comprises a trajectory category index that correlates cursor trajectories to categories.

21. The apparatus of claim 20, wherein the processor utilizes the trajectory category index to determine which category the assistance, displayed in the interactive display panel, should be correlated.
